(19) United States
(12) Patent Application Publication
(10) Pub. No.: US 2019/0310979 A1
(43) Pub. Date: Oct. 10, 2019

(54) ANOMALY DATA PRIORITY ASSESSMENT DEVICE AND ANOMALY DATA PRIORITY ASSESSMENT METHOD

(71) Applicant: MITSUBISHI ELECTRIC CORPORATION, Tokyo (JP)

(72) Inventors: Takahiko MASUZAKI, Tokyo (JP); Shinji KITAGAMI, Tokyo (JP); Junichi YONEYAMA, Tokyo (JP); Takeyuki KIMURA, Tokyo (JP)

(73) Assignee: MITSUBISHI ELECTRIC CORPORATION, Tokyo (JP)

(21) Appl. No.: 16/309,417

(22) PCT Filed: Dec. 8, 2016
(86) PCT No.: PCT/JP2016/086553

§ 371 Date: Dec. 12, 2018

(30) Foreign Application Priority Data
Jul. 6, 2016 (JP) 2016-134072

(51) Int. Cl. G06F 16/2458

(52) U.S. Cl. CPC G06F 16/2465; G06F 16/2477

(57) ABSTRACT

Provided are: a data related information generating unit for generating data related information DL including detection data and air conditioner information of air conditioners; a class classifying unit for creating a plurality of classes on the basis of the air conditioner information related to alarm data extracted by an alarm data extracting unit among the air conditioner information and for classifying the data related information DL into the plurality of classes; a priority setting unit for setting priority to each of a plurality of types of alarm data and the plurality of classes; and a priority calculating unit for assessing co-occurrence of anomaly data extracted by an anomaly data extracting unit and the alarm data, assessing co-occurrence of the alarm data and the plurality of classes, assigning priority about the alarm data and the plurality of classes to the co-occurred anomaly data, and calculating priority of anomaly data.

### TECHNICAL FIELD

The present invention relates to an anomaly data priority assessment device and an anomaly data priority assessment method, and more particularly, to an anomaly data priority assessment device and an anomaly data priority assessment method for assessing priority of a large amount of anomaly data collected from facilities.

### BACKGROUND ART

Various facilities such as lightings and air conditioners are installed in a building, plant, or the like, and a provider of a monitoring service for the building, plant, or the like acquires data on these facilities periodically or each time to monitor the facilities. When the facility to be monitored is an air conditioner, for example, the acquired data includes measured values measured by various sensors and set values, such as a set temperature, a measured temperature, an air conditioning state, a voltage value, a current value, and a pressure value. The acquired data may reach thousands depending on a size of a building or the like.

Data matching a predetermined condition is detected as anomaly data with respect to the acquired data, but since a population parameter of the data is large, a large amount of anomaly data are detected. For all of these numerous anomaly data, it takes a lot of time to analyze and process factors and countermeasures.

In view of this, Patent Literature 1 discloses a technique in which, when a large amount of anomaly data are detected, a facility manager makes confirmation responses to the detected anomaly data, corrects a predetermined condition for detecting anomaly data depending on a frequency of the confirmation responses, and optimizes the number of detected anomaly data.

In addition, Patent Literatures 2 and 3 each disclose a technique in which a histogram on alarms occurred in a facility is created, and when an occurrence frequency of the alarms based on this histogram is high, it is determined that priority of an anomaly is high.

### CITATION LIST

### Patent Literatures

Patent Literature 1: JP 3811162 B2

Patent Literature 2: JP 2013-218725 A

Patent Literature 3: JP 2012-230703 A

### SUMMARY OF INVENTION

### Technical Problem

Minor anomaly data and important anomaly data are included in a large amount of detected anomaly data, and when priority of the anomaly data is unknown, it is necessary to analyze and process factors and countermeasures for all the detected anomaly data. For this reason, according to the technique described in Patent Literature 1, the facility manager judges anomaly data considered to be important to the detected anomaly data, thereby correcting the predetermined condition under which the anomaly data is detected and optimizing the detected anomaly data.

However, according to the technique described in Patent Literature 1, since the facility manager judges priority of the anomaly data, a burden on the facility manager is large, and when there is a mistake in judgment of the facility manager, there is a possibility that reliability of the priority of the anomaly data is lowered. In addition, when the facility manager cannot make a confirmation response, the priority of the anomaly data cannot be assessed.

Therefore, it is an object of the present invention to automatically assess priority of a large amount of anomaly data and to extract important anomaly data from among the large amount of anomaly data with high accuracy.

### Solution to Problem

An anomaly data priority assessment device according to the present invention includes a data storing unit for storing detection data of sensors provided in facilities and event data of events occurred in the facilities in a time series, an anomaly data extracting unit for extracting anomaly data satisfying a predetermined condition from the detection data in the data storing unit, an alarm data extracting unit for extracting a plurality of types of alarm data from the event data in the data storing unit, a data related information generating unit for generating data related information including the detection data and plural pieces of facility information about the facilities related to the detection data, a class classifying unit for creating a plurality of classes on a basis of the facility information related to the alarm data among the plural pieces of facility information and for classifying the data related information into the plurality of classes, a priority setting unit for setting priority to each of the plurality of types of alarm data and for setting priority to each of the plurality of classes, and a priority calculating unit for assessing co-occurrence of the anomaly data and the alarm data, assessing co-occurrence of the alarm data and the plurality of classes, assigning priority about the alarm data and the plurality of classes to the co-occurred anomaly data, and calculating priority of the anomaly data.

Further, the priority setting unit sets priority depending on a time difference between occurrence time of the anomaly data and occurrence time of the alarm data, and when the anomaly data and the alarm data co-occur, the priority calculating unit assigns priority about the plurality of types of alarm data, the plurality of classes, and the occurrence time to the anomaly data and calculates priority of the anomaly data.

Further, the plural pieces of facility information includes at least facility name information to be detected by the sensors, installation location information of the facilities, and system information of the facilities, and the class classifying unit creates the plurality of classes by using the plural pieces of facility information in combination or independently.

Further, the priority calculating unit calculates the priority of the anomaly data by converting the priority into numerical values and multiplying the numerical values of the priority together.

Furthermore, an anomaly data priority assessment method according to the present invention includes: storing detection data of sensors provided in facilities and event data of events occurred in the facilities in a time series; extracting anomaly data satisfying a predetermined condition from the stored detection data: extracting a plurality of types of alarm data from the stored event data; generating data related information including the detection data and plural pieces of facility information about the facilities related to the detection data; creating a plurality of classes on a basis of the facility information related to the alarm data among the plural pieces of facility information and classifying the data related information into the plurality of classes; setting priority for each of the plurality of types of alarm data and setting priority for each of the plurality of classes; and assessing co-occurrence of the anomaly data and the alarm data, assessing co-occurrence of the alarm data and the plurality of classes, assigning priority about the alarm data and the plurality of classes to the co-occurred anomaly data, and calculating priority of the anomaly data.

### Advantageous Effects of Invention

According to the present invention, it is possible to automatically assess priority of a large amount of anomaly data and to extract important anomaly data from the large amount of anomaly data with high accuracy. As a result, it is possible to preferentially analyze and process the important anomaly data.

### BRIEF DESCRIPTION OF DRAWINGS

FIG. 1 is a schematic configuration diagram of a facility management system including an anomaly data priority assessment device according to a first embodiment of the present invention.

FIG. 2 is a hardware configuration diagram of the priority assessment device according to the first embodiment of the present invention.

FIG. 3 is a diagram showing an example of data related information.

FIG. 4 is a diagram showing an example of a class classifying table.

FIG. 5 is a characteristic diagram illustrating co-occurrence of anomaly data and alarm data according to the first embodiment of the present invention.

FIG. 6 is a priority table showing priority, FIG. 6A shows priority with respect to alarm data, FIG. 6B shows priority with respect to occurrence timing, and FIG. 6C shows priority with respect to class classification.

FIG. 7 is a functional block diagram of the anomaly data priority assessment device according to the first embodiment of the present invention.

FIG. 8 is a flowchart showing an anomaly data priority assessment process according to the first embodiment of the present invention.

FIG. 9 is a characteristic diagram illustrating co-occurrence of anomaly data and alarm data according to a second embodiment of the present invention.

### DESCRIPTION OF EMBODIMENTS

Hereinafter, embodiments of the present invention will be described in detail with reference to the drawings.

### First Embodiment

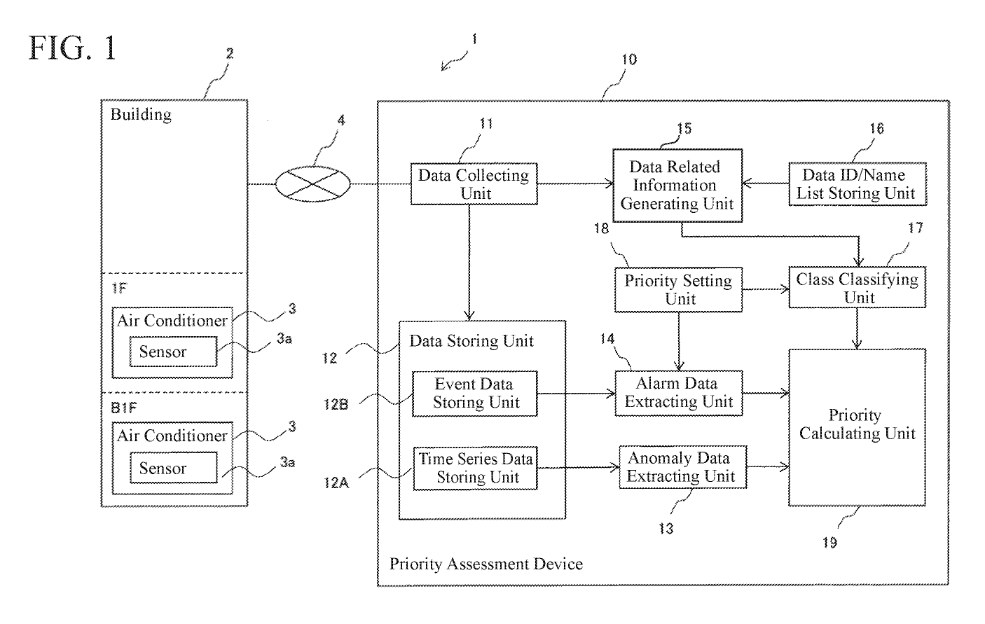

FIG. 1 is an overall configuration diagram of a facility management system 1 including an anomaly data priority assessment device 10 according to the present invention. The facility management system 1 acquires detection data from sensors 3a of air conditioners 3 installed on each floor of a building 2 as facilities, and performs diagnosis and management of the air conditioners 3 on the basis of the acquired detection data. Note that, in addition to the air conditioners 3, the building 2 also includes various facilities such as lighting facilities and power substations, and a large amount of detection data can be obtained therefrom, but in the first embodiment, detection data from the sensors 3a of the air conditioners 3 will be described.

Among the detection data, the facility management system 1 analyzes anomaly data, in particular, for diagnosis and management, and since a large amount of anomaly data are detected, the anomaly data priority assessment device 10 for assessing priority of anomaly data is provided to efficiently analyze the anomaly data.

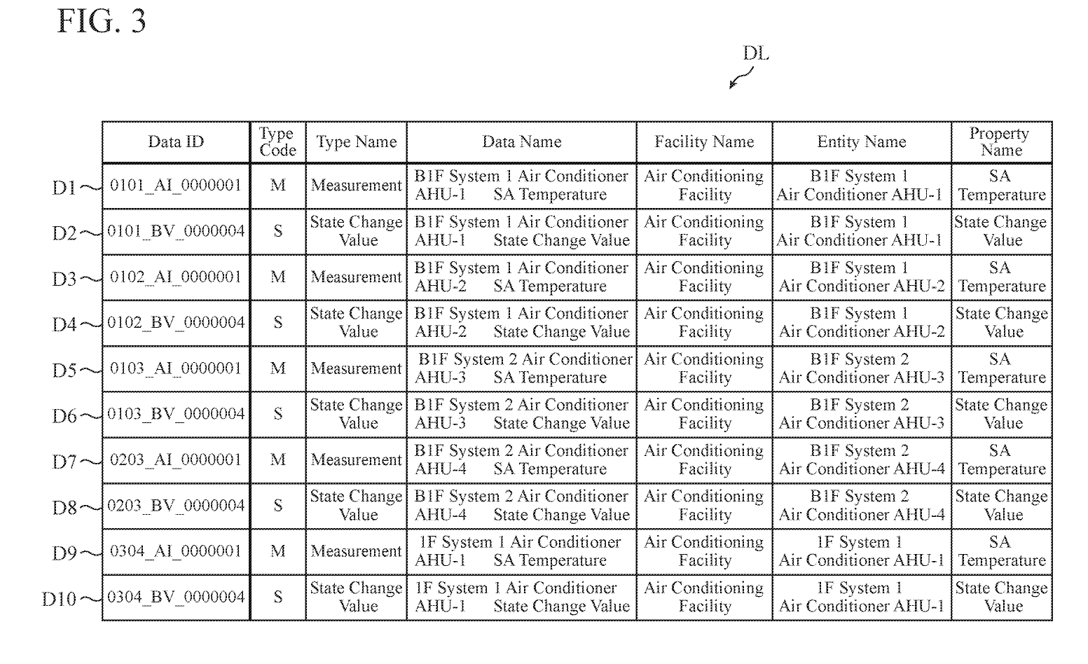

The priority assessment device 10 includes: a data collecting unit 11 for collecting detection data of the sensors 3a and air conditioner information such as installation information and facility information of the air conditioners 3 related to the detection data via a public network 4; a data storing unit 12 that includes a time series data storing unit 12A for storing detection data in a time series and an event data storing unit 12B for storing event data including various alarms, anomalies, and the like concerning the air conditioners 3 in a time series; an anomaly data extracting unit 13 for extracting anomaly data indicating an anomaly from the detection data stored in the time series data storing unit 12A; an alarm data extracting unit 14 for extracting alarm data such as an alarm and an anomaly from the event data stored in the event data storing unit 12B; a data related information generating unit 15 for generating a data related information list DL (see FIG. 3) obtained by relating the detection data and the air conditioner information on the basis of the detection data and the air conditioner information collected by the data collecting unit 11; a data ID/name list storing unit 16 for listing and storing information names of various information on the air conditioner information; a class classifying unit 17 for classifying the data related information list DL into a plurality of classes; a priority setting unit 18 for setting priority to each of the alarm data extracted by the alarm data extracting unit 14 and each of the classes classified by the class classifying unit 17; and a priority calculating unit 19 for calculating priority of the anomaly data on the basis of the anomaly data extracted by the anomaly data extracting unit 13, the alarm data extracted by the alarm data extracting unit 14, and the classes classified by the class classifying unit 17.

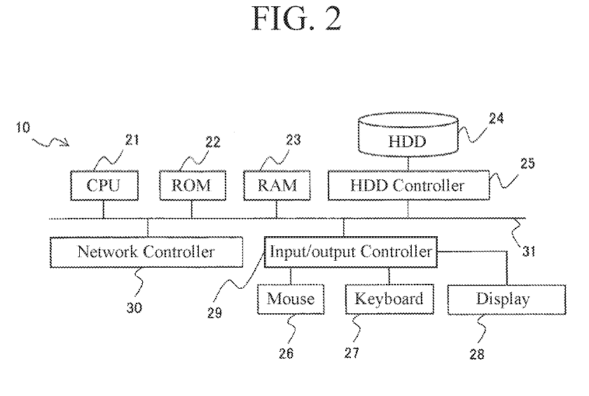

FIG. 2 is a hardware configuration diagram of a computer constituting the priority assessment device 10 according to the first embodiment. The computer constituting the priority assessment device 10 can be implemented by a general-purpose hardware configuration. In other words, as shown in FIG. 2, the computer is constituted by connecting a CPU 21, a ROM 22, a RAM 23, an HDD controller 25 connected to a hard disk drive (HDD) 24, an input/output controller 29 for connecting a mouse 26 and a keyboard 27 provided as input means and a display 28 provided as a display device, and a network controller 30 provided as communication means via an internal bus 31.

The data storing unit 12 and the data ID/name list storing unit 16 are configured by the hard disk drive (HDD) 24. The anomaly data extracting unit 13, the alarm data extracting unit 14, the class classifying unit 17, the priority setting unit 18, and the priority calculating unit 19 are configured by the CPU 21, the ROM 22, and the RAM 23.

Next, each configuration of the priority assessment device 10 will be described. The data collecting unit 11 and the data storing unit 12 are well-known configurations, and a detailed description thereof will be omitted. In addition to the time series data storing unit 12A and the event data storing unit 12B, the data storing unit 12 includes a storing unit (not shown) for storing various data such as classes classified by the class classifying unit 17 and various calculation results.

The anomaly data extracting unit 13 extracts anomaly data from the detection data stored in the time series data storing unit 12A by a rule base method. In the rule base method, a predetermined rule (predetermined condition), for example, a rule (condition) is set in advance such that when a signal is continuously output from the sensor 3a for 10 minutes, it is determined that the signal is anomaly data, and when the detection data matches this rule, it is determined that the detection data is anomaly data.

The extracted anomaly data includes a data ID of corresponding detection data, information on a time at which an anomaly has occurred, facility information, and information on the sensor 3a in which the anomaly has occurred, such as sensor information.

The alarm data extracting unit 14 extracts alarm data including a character string concerning an alarm or an anomaly, such as “real alarm”, “alarm”, or “anomaly”, from the event data stored in the event data storing unit 12B. In the first embodiment, three kinds of alarm data, “real alarm”, “alarm”, and “anomaly” described above are extracted. The extracted alarm data includes a data ID of corresponding alarm data, information on a time at which an alarm has occurred, information on the facility in which the alarm has occurred, such as facility information, facility location information, and facility system information.

The data related information generating unit 15 extracts various information, such as a data ID of the detection data, air conditioner installation information, and air conditioner facility information, from the detection data and the air conditioner information collected by the data collecting unit 11. Furthermore, the data related information generating unit 15 sets the extracted various information such as data ID, air conditioner installation information, and air conditioner facility information as data items and generates a set of data related information by collecting these data items.

FIG. 3 shows an example of the data related information list DL generated by the data related information generating unit 15. Data related information D1 to D10 is generated for each detection data, and a list of these data related information D1 to D10 is the data related information list DL shown in FIG. 3. In FIG. 3, data related information for ten pieces of data is shown. The data related information D1 to D10 is given a data ID for identifying each piece of data. Then, items such as a type code name, a type name, a data name, a facility name, an entity name, and a property name are associated with the data ID. In the first embodiment, output signals from the sensor 3a are classified into a plurality of items depending on the type.

The type name is signal type information indicating a signal type to which the output signal from the sensor 3a belongs, and the type code name is obtained by coding the signal type information. The data name is a name given to an output signal value from each of the sensors 3a, and in the first embodiment, in accordance with a predetermined naming rule, the data name includes an installation location name indicating an installation location of each of the air conditioners 3 to be detected by the corresponding sensor 3a, a facility type name indicating each type of air conditioner 3, and an output type name indicating each type of output signal from each of the sensors 3a. The facility name is a facility name indicating what kind of facility each air conditioner 3 is. The entity name includes a facility specifying name including the installation location name and the facility type name extracted from the data name by being analyzed by the data related information generating unit 15. The property name includes the output type name extracted from the data name by being analyzed by the data related information generating unit 15.

The property name is a signal name given to the output signal from each sensor 3a, classified by a type of signal represented by “AI” and the like, and classified by a type (type name) of signal represented by “measurement” and the like. The signal type code and the type name classify the property name (signal name) on the basis of different classification criteria even for information indicating the same signal type.

For example, the detection data corresponding to the data related information D1 indicates that it is data output from the sensor 3a that measures the SA temperature (supply air temperature) of the air conditioner 3 installed on a B1F (first basement floor). It is understood that the detection data corresponding to the data related information D1 is signal data indicating a type called a supply air temperature from the property name “SA temperature”, classified into a group called a signal input as an analog signal on the basis of “AI” according to classification criteria in the data ID, and simultaneously classified into a group called data obtained by measurement on the basis of “measurement” according to classification criteria in the type name.

The data ID/name list storing unit 16 stores data items for generating the data related information D1 to D10, that is, names of various pieces of information such as a data 1D, air conditioner installation information, and air conditioner facility information as data items.

The class classifying unit 17 classifies the data related information list DL into classes on the basis of a class obtained by collecting a plurality of data items highly related to each other out of the data items of the data related information list DL or a class composed of one data item. In particular, class classification is performed on the basis of data items highly related to the alarm data.

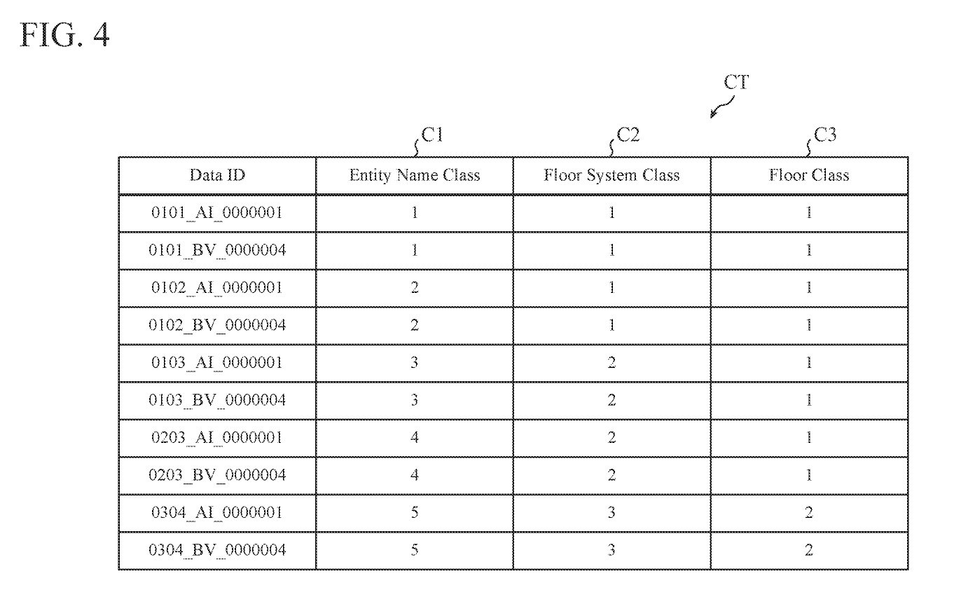

In the first embodiment, the data related information list DL is classified into three classes C1, C2, C3 of “entity name class”, “floor system class”, and “floor class”. A class classifying table CT classified into classes is shown in FIG. 4. In FIG. 4, the entity name class C is used to classify data IDs having the same entity name (a location name and a facility name of the air conditioner 3 installed) into the same class. The floor system class C2 is used, by extracting a character string “floor” or “F” from a signal name as floor information and extracting a character string called a system from the signal name as system information, to classify signals having the same character strings into the same class. The floor class C3 is used, by extracting the character string “floor” or “F” from the signal name as the floor information, to classify signals having the same floor into the same class.

In FIGS. 3 and 4, since data ID “0101_AI_0000001” and data ID “0101 BV_0000004” both have entity name “B1F system 1 air conditioner AHU-1”, the same location name, and the same facility name, as shown in FIG. 4, they are classified into the same class in the entity name class. Regarding the other data IDs, the class classifying table CT shown in FIG. 4 is generated by classifying matching data IDs into the same class with respect to the entity name, the floor system, and the floor.

The priority setting unit 18 sets priority to three types of alarm data, “real alarm”, “alarm”, and “anomaly”. “Real alarm” has the highest priority, and then the priority is set in the order of “alarm” and “anomaly”. “Real alarm” is a signal output when a facility manager judges that it is actually an alarm, and “alarm” is a signal output when the detection data of the sensors 3a exceeds a predetermined threshold value, and “anomaly” is a signal output when the detection data of the sensors 3a deviates from a normal value.

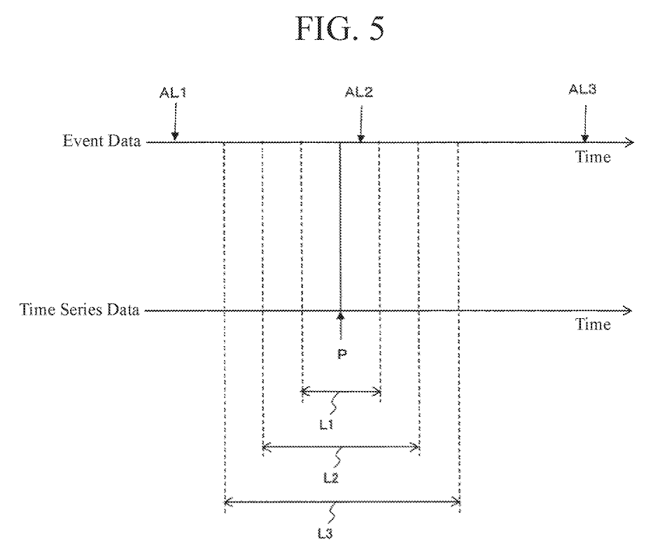

The priority setting unit 18 sets priority based on proximity of occurrence time (timing) of the alarm data and occurrence time of the anomaly data. In other words, when the occurrence time of the alarm data and the occurrence time of the anomaly data are close, it is determined that relevance between the alarm data and the anomaly data is high, and the priority in this case is set high. In other words, as the occurrence time of the anomaly data and the occurrence time of the alarm data get closer, it is determined that the relevance between the two is higher and the priority is set higher, and as the occurrence time of the anomaly data and the occurrence time of the alarm data are further apart, it is determined that the relevance between the two is lower and the priority is set lower. For this reason, as shown in FIG. 5, for example, the priority is set in three ranges of ranges L1, L2, and L3 related to anomaly data P in time series data.

In addition, the priority setting unit 18 sets priority for the three classes of “entity name class”, “floor system class”, and “floor class” in the class classifying table CT shown in FIG. 4. Since the installation location and the facility name of the air conditioner 3 in “entity name class” are highly related to the alarm data, the priority of “entity name class” is set higher than that of the other classes. For this reason, “entity name class” has the highest priority, and then the priority is set in the order of “floor system class” and “floor class”.

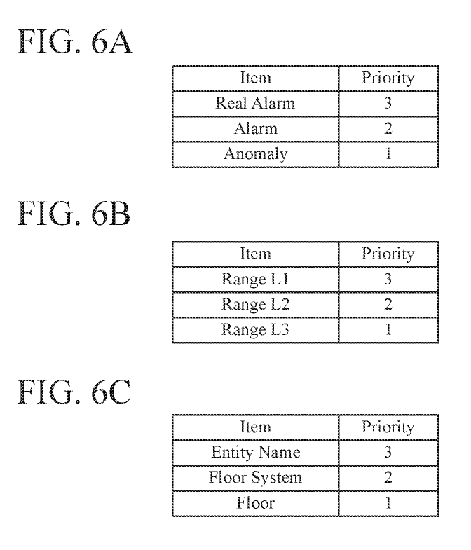

FIGS. 6A, 6B, and 6C show priority tables for the alarm data, the timing, and the class. As shown in FIGS. 6A, 6B, and 6C, each priority is set by converting the priority into a numerical value. As shown in FIG. 6A, regarding the alarm data, priority “3” is set for “real alarm”, priority “2” is set for “alarm”, and priority “I” is set for “anomaly”. Regarding the timing, priority “3” is set for “range L1”, priority “2” is set for “range L2”, and priority “1” is set for “range L3”. Further, regarding the class, priority “3” is set for “entity name class”, priority “2” is set for “floor system class”, and priority “1” is set for “floor class”. This priority table is stored in the data storing unit 12.

The priority calculating unit 19 performs co-occurrence assessment of the anomaly data and the alarm data, performs co-occurrence assessment of the alarm data and class classification, gives priority relating to the alarm data and the class classification to the anomaly data, and calculates priority of the anomaly data. A priority calculation process performed by the priority calculating unit 19 will be described in detail below.

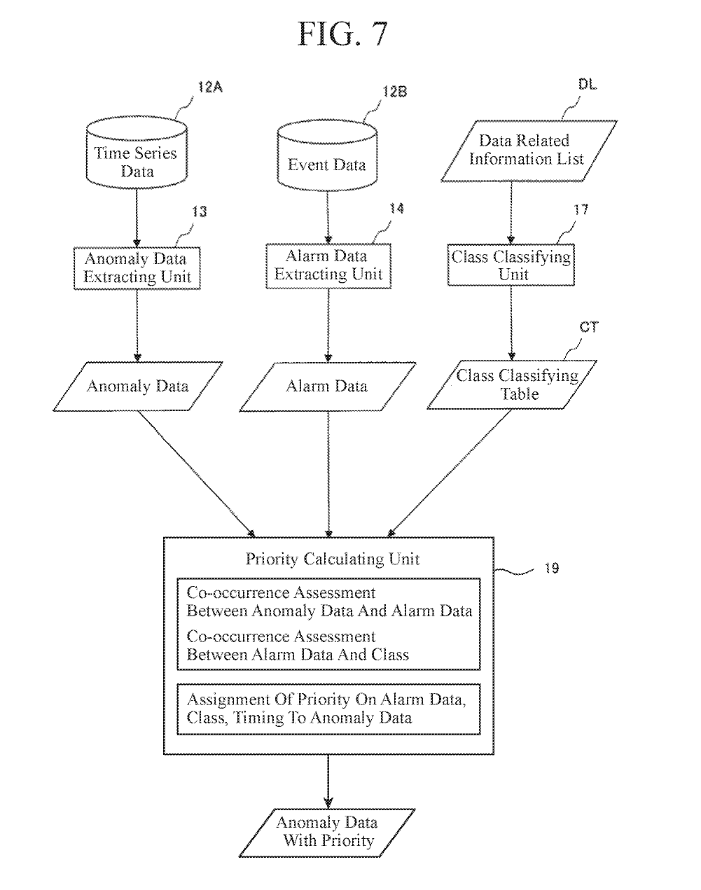

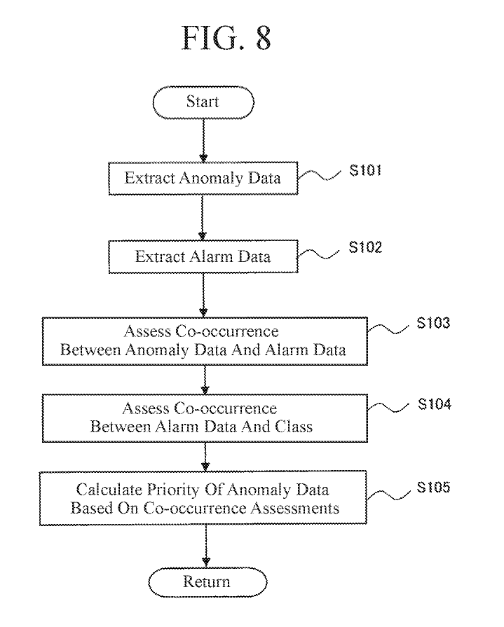

Next, anomaly data priority assessment by the priority assessment device 10 will be described in detail with reference to FIGS. 7 and 8. FIG. 7 shows a functional block diagram of the priority assessment device 10, and FIG. 8 shows a flowchart of an anomaly data priority assessment process by the priority assessment device 10.

In step S101 in FIG. 8, as shown in FIG. 7, the anomaly data extracting unit 13 extracts anomaly data from the detection data stored in the time series data storing unit 12A by the rule base method, and then the process proceeds to step S102.

In step S102, as shown in FIG. 7, the alarm data extracting unit 14 extracts alarm data of “real alarm”, “alarm”, and “anomaly” from the event data stored in the event data storing unit 12B, and then the process proceeds to step S103.

In step S103, co-occurrence of the anomaly data and the alarm data is assessed, and then the process proceeds to step S104. In other words, in step S103, the co-occurrence of the anomaly data and the alarm data is assessed on the basis of time information of anomaly occurrence included in the anomaly data and time information of alarm occurrence included in the alarm data. The co-occurrence means that two events are closely related.

This co-occurrence assessment will be described with reference to FIG. 5. As shown in FIG. 5, the anomaly data P occurs in the time series data, and an anomaly AL1, an alarm AL2, and a real alarm AL3 occur in the event data. At this time, on the basis of occurrence time of the anomaly data P and occurrence times of the anomaly AL1, the alarm AL2, and the real alarm AL3, it is detected whether the anomaly AL1, the alarm AL2, or the real alarm AL3 occurs near the anomaly data P. With respect to the anomaly data P, if any of the anomaly AL1, the alarm AL2, and the real alarm AL3 exists in the range L1, L2, L3, it is assessed that it co-occurs with the anomaly data P. In FIG. 5, since the alarm AL2 occurs within the range L1 relating to the anomaly data P, it is assessed that the anomaly data P and the alarm AL2 co-occur. Note that, since the anomaly AL1 and the real alarm AL3 are outside the range L3 related to the anomaly data P, it is assessed that they do not co-occur with the anomaly data P.

In step S104, co-occurrence of the extracted alarm data and the classified class is assessed, and the process proceeds to step S105. In other words, in step S104, on the basis of information such as data ID included in the alarm data, time information at which the alarm has occurred, facility information, facility location information, and facility system information, it is assessed whether the alarm data co-occurs with any of the three classes. For example, as shown in FIG. 5, when the alarm data is the alarm AL2 and the alarm data of this alarm AL2 includes “B1F system 1 air conditioner AHU-1” and “air conditioning facility”, it is assessed that the alarm AL2 co-occurs with the class “1” of “entity name class” in the class classifying table CT shown in FIG. 4. Similarly, it is assessed whether the alarm data of the alarm AL2 co-occurs with “floor system class” or “floor class” of the class classification.

In step S105, on the basis of the co-occurrence assessment in steps S103 and S104, priority with respect to the extracted anomaly data P is calculated. In step S103, since it is determined that the anomaly data P co-occurs with the alarm AL2, the priority “2” is assigned to the anomaly data P on the basis of the priority table shown in FIG. 6A. Further, since the alarm AL2 is located within the range L1 with respect to the anomaly data P, the priority “3” is assigned to the anomaly data P on the basis of the priority table shown in FIG. 6B. Furthermore, since it is assessed in step S104 that the alarm AL2 co-occurs with the “entity name class”, the priority “3” is given to the alarm AL2 on the basis of the priority table shown in FIG. 6C. At this time, since the alarm AL2 and the anomaly data P co-occur, the priority “3” is assigned to the anomaly data P.

Therefore, by assigning the priority “2”, “3”, and “3” to the anomaly data P and multiplying these together, priority “18” is calculated comprehensively. When the calculation of the priority for one anomaly data P is completed, the process returns to step S101, and the priority is similarly calculated for anomaly data P to be extracted next.

As described above, the priority can be automatically calculated for all anomaly data P to be extracted on the basis of the priority assessment process by the priority assessment device 10. As a result, it is possible to determine a level of priority with respect to the large amount of anomaly data P all extracted, and in particular, it is possible to extract anomaly data P having high priority with high accuracy and to preferentially analyze and process the anomaly data P having the high priority.

Further, with regard to minor anomaly data P having low priority, it is also effective to prevent such anomaly data P having the low priority from being extracted by modifying the predetermined rule of the rule base method in the anomaly data extracting unit 13. As a result, it is possible to improve extraction accuracy of the anomaly data having the high priority.

Note that, in the first embodiment described above, the priority of the alarm data, the class classification, and the timing is set to the three stages, but the number of stages of the priority may be increased by increasing the number of items and types related to the alarm data, the class classification, and the timing. By increasing the number of stages of the priority, it is possible to determine in detail a level of the priority of the anomaly data.

### Second Embodiment

Next, a second embodiment will be described. The second embodiment is the same as the first embodiment except that priority regarding occurrence timing of anomaly data and alarm data is omitted.

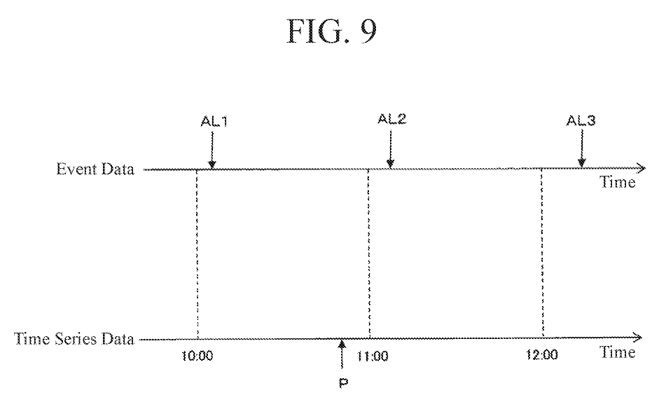

In the second embodiment, as shown in FIG. 9, co-occurrence of anomaly data P and alarm data, that is, an anomaly AL1, an alarm AL2, and a real alarm AL3, is determined in unit time. In FIG. 9, the unit time is set to one hour, and for example, when the anomaly data P occurs between 10:00 and 11:00, it is determined whether the anomaly AL1, the alarm AL2, or the real alarm AL3 occurs within this time. In FIG. 9, since the anomaly AL1 occurs between 10:00 and 11:00 in which the anomaly data P occurs, it is determined that the anomaly data P and the anomaly AL1 co-occur.

Note that the alarm AL2 is temporally closer to the anomaly data P than the anomaly AL1, but in the second embodiment, since the co-occurrence is determined in units of time in which the anomaly data P occurs, it is determined that the anomaly data P and the alarm AL2 do not co-occur.

Assignment of priority to the anomaly data P is the same as that in the first embodiment described above. The priority is given to the anomaly data P on the basis of FIGS. 6A and 6C, and numerical values regarding the priority are multiplied together, thereby calculating overall priority.

According to the second embodiment, since assignment of the priority with respect to the occurrence timing is omitted, a calculation amount for calculating the priority can be reduced.

It is to be noted that the present invention can freely combine embodiments, modify any component in the embodiments, or omit any component in the embodiments within the scope of the invention.

### INDUSTRIAL APPLICABILITY

An anomaly data priority assessment device according to the present invention can automatically assess priority of a large amount of anomaly data and extract important anomaly data from among the large amount of anomaly data with high accuracy, and is suitable for use as an anomaly data priority assessment device and the like for assessing priority of a large amount of anomaly data collected from facilities.

### REFERENCE SIGNS LIST

1: facility management system, 2: building, 3: air conditioner, 3a: sensor, 4: public network, 10: priority assessment device, 11: data collecting unit, 12: data storing unit, 12A: time series data storing unit, 12B: event data storing unit, 13: anomaly data extracting unit, 14: alarm data extracting unit, 15: data related information generating unit, 16: data ID/name list storing unit, 17: class classifying unit, 18: priority setting unit, 19: priority calculating unit, AL1: anomaly, AL2: alarm, AL3: real alarm, C1: entity name class, C2: floor system class, C3: floor class, CT: class classifying table, DL: data related information list, L1, L2, L3: range, P: anomaly data.

1. An anomaly data priority assessment device comprising:
a processor; and
a memory storing instructions which, when executed by the processor, causes the processor to perform processes of:
storing detection data of sensors provided in facilities and event data of events occurred in the facilities in a time series;
extracting anomaly data satisfying a predetermined condition from the stored detection data;
extracting a plurality of types of alarm data from the stored event data;
generating data related information including the detection data and plural pieces of facility information about the facilities related to the detection data;
creating a plurality of classes on a basis of the facility information related to the alarm data among the plural pieces of facility information and classifying the data related information into the plurality of classes;
setting priority to each of the plurality of types of alarm data and setting priority to each of the plurality of classes; and
assessing co-occurrence of the anomaly data and the alarm data, assessing co-occurrence of the alarm data and the plurality of classes, assigning priority about the alarm data and the plurality of classes to the co-occurred anomaly data, and calculating priority of the anomaly data.

2. The anomaly data priority assessment device according to claim 1,
wherein the processor sets priority depending on a time difference between occurrence time of the anomaly data and occurrence time of the alarm data, and
when the anomaly data and the alarm data co-occur, the processor assigns priority about the plurality of types of alarm data, the plurality of classes, and the occurrence time to the anomaly data and calculates priority of the anomaly data.

3. The anomaly data priority assessment device according to claim 1,
wherein the plural pieces of facility information includes at least facility name information to be detected by the sensors, installation location information of the facilities, and system information of the facilities, and
the processor creates the plurality of classes by using the plural pieces of facility information in combination or independently.

4. The anomaly data priority assessment device according to claim 1,
wherein the processor calculates the priority of the anomaly data by converting the priority into numerical values and multiplying the numerical values of the priority together.

5. An anomaly data priority assessment method comprising:
storing detection data of sensors provided in facilities and event data of events occurred in the facilities in a time series;
extracting anomaly data satisfying a predetermined condition from the stored detection data;
extracting a plurality of types of alarm data from the stored event data;
generating data related information including the detection data and plural pieces of facility information about the facilities related to the detection data;
creating a plurality of classes on a basis of the facility information related to the alarm data among the plural pieces of facility information and classifying the data related information into the plurality of classes;
setting priority for each of the plurality of types of alarm data and setting priority for each of the plurality of classes; and
assessing co-occurrence of the anomaly data and the alarm data, assessing co-occurrence of the alarm data and the plurality of classes, assigning priority about the alarm data and the plurality of classes to the co-occurred anomaly data, and calculating priority of the anomaly data.
